(19) United States
(12) Patent Application Publication
(10) Pub. No.: US 2024/0288199 A1
(43) Pub. Date: Aug. 29, 2024

(54) HEATER ASSEMBLY

(71) Applicant: Goodrich Corporation, Charlotte, NC (US)

(72) Inventors: Piotr Jacek KROCZEK, Nieciszów (PL); Adrian TARNOWSKI, Wroclaw (PL); Pawel SWIRNIAK, Prochowice (PL)

(21) Appl. No.: 18/441,406

(22) Filed: Feb. 14, 2024

(30) Foreign Application Priority Data
Feb. 27, 2023 (EP) 23461524.3

(51) Int. Cl. F24H 9/1818; F24H 1/10; F24H 9/02; F24H 1/00; F24H 9/00

(52) U.S. Cl. CPC F24H 9/1818; F24H 1/102; F24H 9/02; F24H 1/009; F24H 9/0015; F24H 2250/02

(57) ABSTRACT

A heater assembly includes a heater assembly housing having a housing body with one or more port openings formed therethrough. The heater assembly can also include a heater element located within the housing body and shaped to form a heater loop around each of the one or more port openings.

### CROSS REFERENCE TO RELATED APPLICATIONS

This application claims priority to European Patent Application No. 23461524.3 filed Feb. 27, 2023, the entire contents of which is incorporated herein by reference.

### TECHNICAL FIELD

The present disclosure is concerned with providing an assembly, and, in particular a heater assembly, such as for ports in a water system, such as the fill and overflow ports of a water system. The water system can, for example, be a system for providing potable or fresh water in an aircraft.

### BACKGROUND

Water systems often include a tank or storage vessel to store water which can then be plumbed to other parts of the system to provide water to different parts of the system from the storage tank/vessel. The tank will need to be periodically re-filled. Typically, the tank is provided with a fill port to which a fill line, connected to a source of water, is connected for re-filling the tank from the source. The tank may also be provided with an overflow or overfill line via which water can exit the tank if the tank is overfilled. The overflow water exits from an overflow port on the tank. During the tank filling process, the fill port, and, where present, the overflow port, will be open. In some applications, the ports are left open after filling. The ports may be provided in an operating panel that is covered by a door or panel when not in use. In certain environments, e.g. where the tank is subjected to movement or vibration or in environments where debris or contaminants exits which should not be allowed to get into the tank, a closure or cap assembly is provided at the ports to close the port(s) when not being filled. In an arrangement with a fill port and an overflow port, each port may be provided with its own cap or closure or, alternatively, a single closure can be provided that covers both ports, when closed. Such assemblies may be used, for example, in aircraft. An aircraft typically has water stations in the cabin for dispensing drinking water during flight. The aircraft has a storage tank filled with potable water and plumbing to provide water from the tank to the stations as required. The tank is re-filled between flights by ground crew, by connecting an external source of water, e.g. a water truck, to the tank via a hose connected to the fill line attached to the fill port.

Because such assemblies are often located in places where they are subject to extreme environmental conditions, e.g. on the outside of an aircraft, where temperatures can be very low, there is a risk of water in and around the ports freezing. Heaters are typically provided on the assembly to heat the housing and/or ports.

Whilst existing assemblies are effective in heating the ports, there is a need for a more efficient heating assembly.

### SUMMARY

According to the disclosure, there is provided a heater assembly comprising: a heater assembly housing having a housing body with one or more port openings formed therethrough; a heater element located within the housing body and shaped to form a heater loop around each of the one or more port openings

Also provided is a fill port assembly having such a heater assembly, and a method of assembling a heater assembly to a fill port assembly.

### BRIEF DESCRIPTION

Examples of the assembly according to this disclosure will be described by way of example only and with reference to the drawings. It should be noted that variations are possible within the scope of the claims.

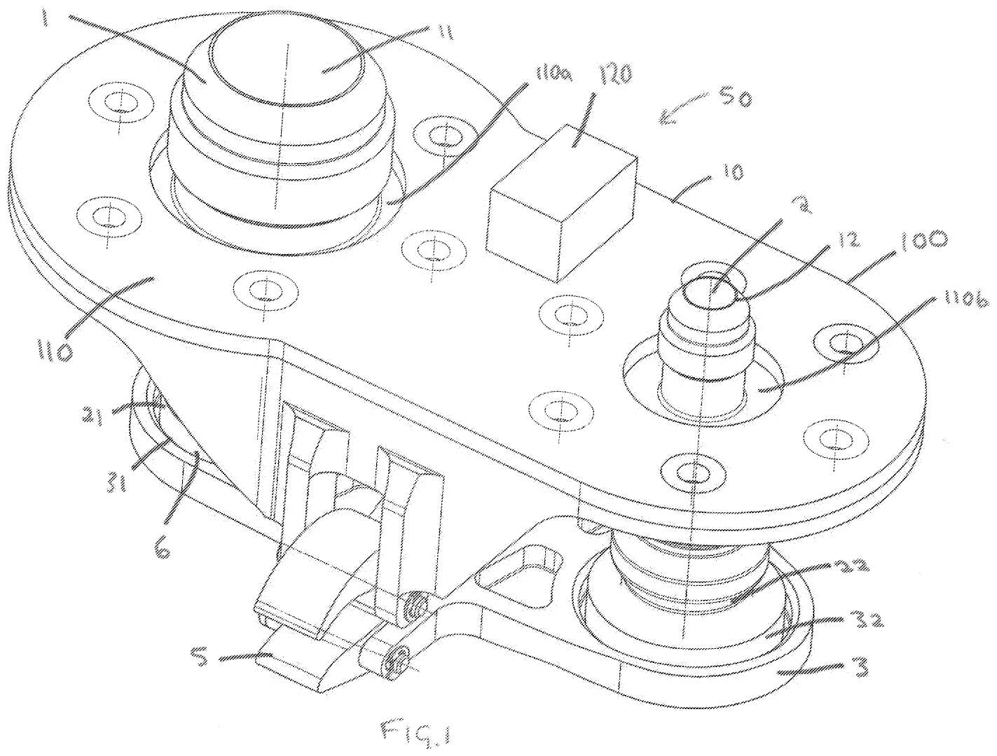

FIG. 1 is a perspective view of an example of a known assembly for a fill port and an overflow port of a water system.

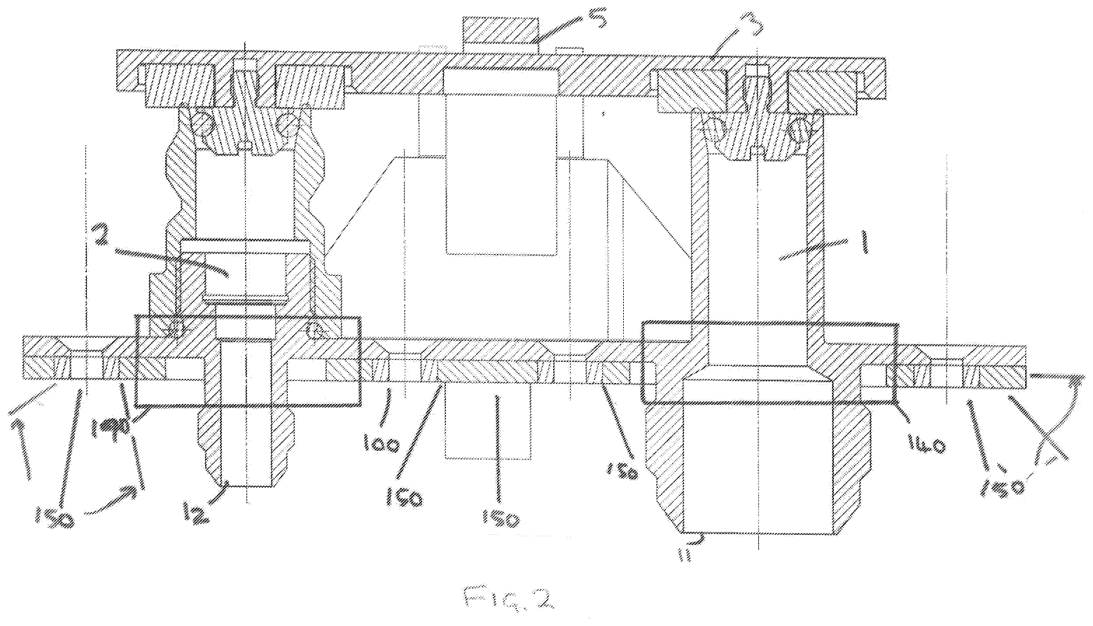

FIG. 2 is a side view of a known assembly such as shown in FIG. 1.

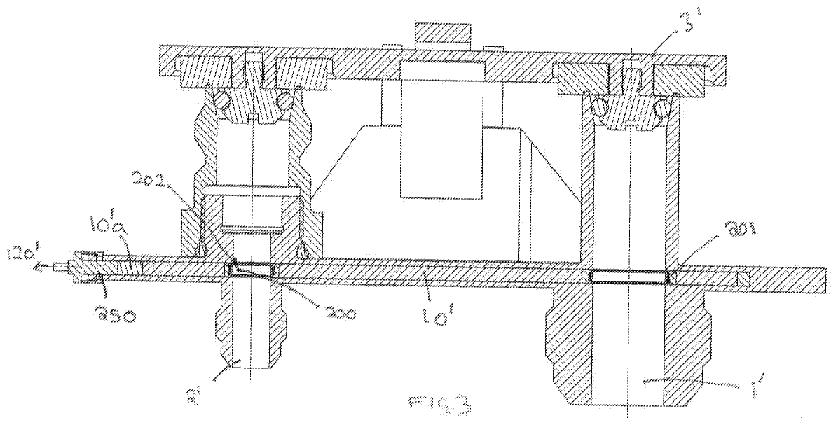

FIG. 3 is a view of an assembly according to this disclosure incorporated in a fill port.

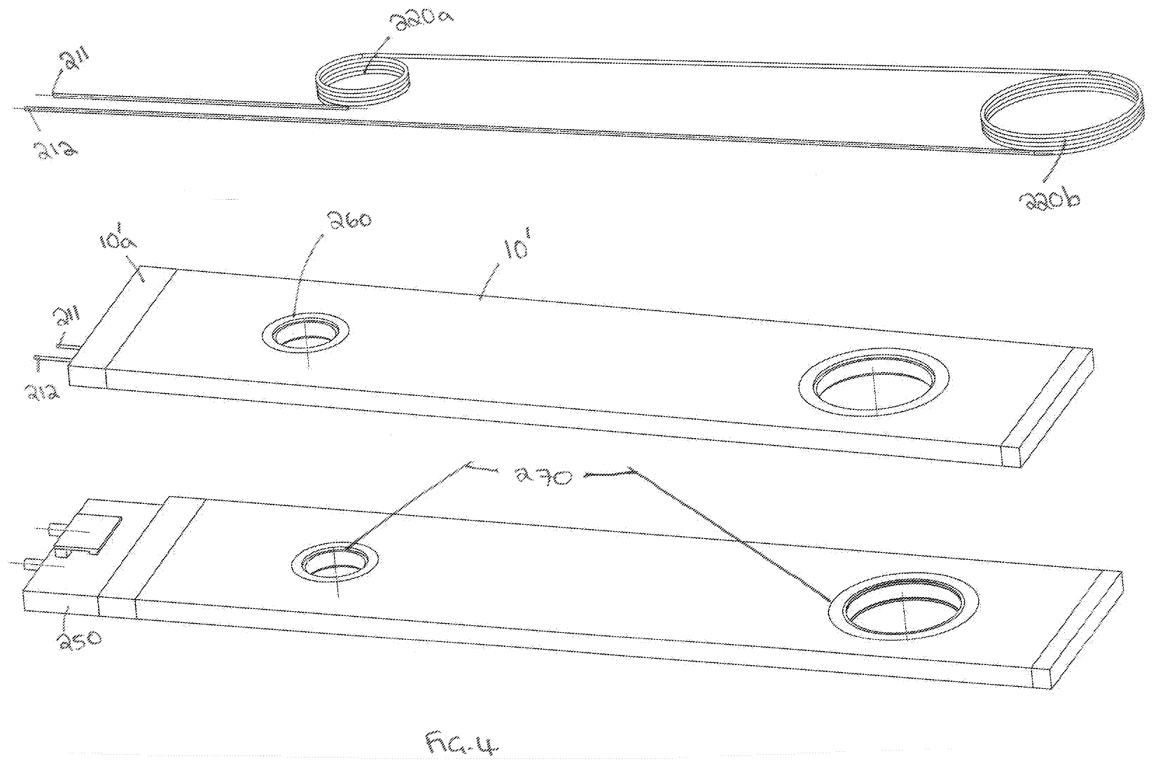

FIG. 4 is a view showing component parts of a heater assembly of an assembly such as shown in FIG. 3.

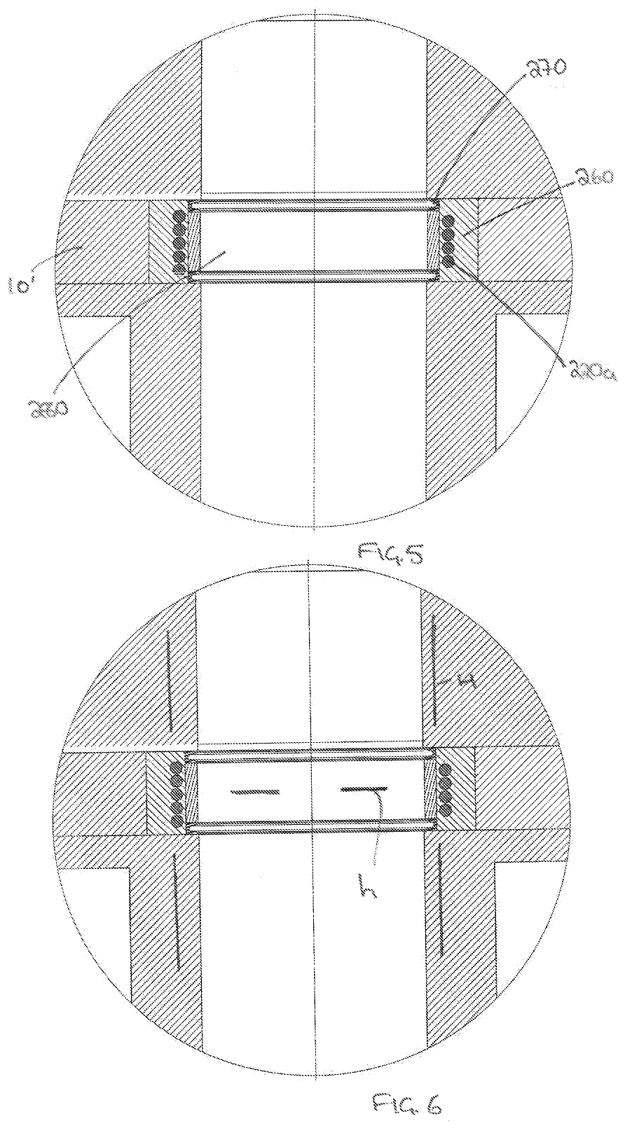

FIG. 5 is a close up view of a heater assembly in a fill port such as shown in FIG. 3.

FIG. 6 shows the heating properties of a heater assembly of an assembly such as shown in FIG. 3.

### DETAILED DESCRIPTION

By way of background, an example of a known port closure assembly 50 will first be described, with reference to FIGS. 1 and 2.

In this assembly, a fill port 1 and an overflow port 2 are provided in a housing 10. These will be in fluid connection at a first end 11, 21 with the storage tank or other vessel to be filled via the fill port. The second end 12 of the fill port 1 is provided with a respective fitting 31 configured to be fluidly connected to a fill line (not shown) when the tank is being filled. The second end 22 of the overflow port 2 is provided with a fitting configured to be fluidly connected to an overflow line (not shown). A cap 3 is provided to cover the second ends 12, 22 of the fill and overflow ports in the closed state. In the example shown, a single cap is provided that covers both ports 1, 2 as this simplifies the closing operation by the user and reduces the risk of a port being inadvertently left open after filling. Other known assemblies have a separate cap for each port.

The cap 3 is mounted to the assembly housing 10 by a hinge arrangement (not shown) adjacent the second ends of the ports, and is provided with a lever and latch mechanism 5 to open and close the cap 3. The inner surface of the cap, that comes into contact with the second end of the port(s) when closed, is preferably provided with a seal 6. An additional seal, such as an O-ring seal (not shown), may also be provided around the second end of the port(s).

The Figures show the assembly viewed from the bottom, as the present disclosure focuses on the heater assembly, which can best be seen when the port assembly is viewed from underneath.

Typically, a heater such as a silicone heater 100 is provided in the form of a silicone structure 110 e.g. a plate or sheet shaped to fit over the lower surface of the housing 10, and having openings 110a, 110b through which the ports extend. Electrical wires (not shown) are formed within the silicone structure which, due to their electrical resistance, generate heat in the silicone structure 110 when power is applied to the wires. Typically, a power source 120 is mounted to the silicone structure (here shown on the bottom surface of the silicone structure).

Because of the structure of the known heater, some of the heat that is generated is emitted to the atmosphere in a direction away from the housing and parts of the fill port to be heated. This is lost heat and the structure is, therefore, inefficient and wastes power. This can be seen in FIG. 2 which shows the fill port assembly and heater from a side view (this time not inverted—i.e. in the usual orientation of the assembly in use). The critical areas of the assembly that need to be heated are shown by rectangles 140. These are the areas where residual water can accumulate after it has been supplied to the tank via the fill port. At low temperatures, this can freeze and thus block the flow of water at the next filling operation. Whilst the heater 100 does heat those areas, the current heaters transfer heat in all directions, including directions 150 that do not play any role in freeze protection. This is, therefore, wasted heat and makes the heater inefficient. These inefficiencies mean that in order to provide sufficient heating to the critical areas, a bigger power supply will be needed due to the wasted heat or, alternatively, for a given size of power supply, insufficient heat will be provided to the critical areas.

Another problem with these conventional heaters is that, if the silicone structure 110 is damaged e.g. during filling, the entire heater assembly will need to be replaced including the wires and the power supply. Further, because the heater assembly is formed as a plate to be attached to the housing, it must be accurately machined and positioned during assembly to avoid further inefficiencies and non-aligned edges that can cause damage.

The solution provided by this disclosure provides a more efficient heater assembly for a fill port, that avoids these problems and can be manufactured and assembled easily, quickly and at lower cost. The solution provided in this disclosure will now be described with reference to FIGS. 3 to 6.

The core of the disclosure is a heater assembly comprising a heat conducting element 200 incorporated in the housing 10′ itself and positioned to provide targeted heating around the hole/holes 210, 220 in the housing through which the port/ports 1′, 2′ pass. This replaces the silicone structure 110 of the known heater solutions described above. The fill port assembly to which the heater assembly is mounted is otherwise the same as the conventional assembly as described above.

Again, the solution will be described with reference to a port assembly having a fill port l′ and an overflow port 2′ on a single housing 10′, and having a hinged cap 3′. It should be noted, however, that the heater assembly could be used with different port assemblies including, but not limited to assemblies having a single port or even more than two ports, and assemblies having no cap or caps having a different configuration. These features are not relevant to the disclosure and will not be described further in any detail.

The heater assembly according to the disclosure comprises a heat conducting structure or heating element configured to be assembled inside the body of the housing 10′ of a port assembly. The heating element 200 is formed as a structure that can be embedded in the housing body and which defines a heat element loop 220a, 220b to be positioned, in use, around the periphery of the or each opening 201, 202 in the housing body through which the or each port 1′, 2′ passes. A power supply 300 can be electrically connected to the heater element to provide power to element.

More specifically, the heater element 200 has a wire structure shaped to define the loop or loops 220a, 220b and having wire ends 230a, 230b for connection to a power supply 120′ to apply current to the structure to cause it to heat and, therefore, to heat the area around it within the housing and around the port.

In the most preferred embodiment, the heater element 200 is made of a carbon nanotube (CNT) material as described further below.

FIG. 3 shows how a heater according to the disclosure can be mounted in a fill port assembly. The overall assembly with ports 1′, 2′, housing 10′ and cap 3′ is, in this example the same as the assembly described above and shown in FIG. 1. The difference is in the heater assembly which is formed as a heating element 200 within the body of the housing 10′. Whilst shown used in a two-port assembly with a hinged cap, it should be noted that a heater assembly according to this disclosure may be used in other assemblies, with only one port or with more ports and with different forms of port closure.

In this example, two openings 201, 202 are provided in the housing 10′, one opening for each of the fill port l′ and the overflow port 2′, as is conventional.

The heater element 200, as will be described in more detail below, is located in the housing to ensure better thermal transfer. The heater element 200 forms a heating loop 220a, 220b around each of the openings 201, 202 in the housing 10′.

Power is provided to the heater element by application of current. In the example shown, the ends 230a, 230b extend to and from one end 10′a of the housing 10′ where they are connected to a power supply e.g. by means of a connector plug 250 that electrically connects to the heater structure ends and connects to a power supply 120′.

As best seen in FIG. 4, the heater element 200 according to this disclosure is in the form of a wire or yarn structure having a first end 211 and a second end 212. The structure is coiled or bent at one or more locations between the two ends to form heat loops 220a, 220b and then turns back on itself such that the second end 212 ends adjacent the first end 211. In the example shown, the portions of the heater structure between the loops are straight or substantially straight, but this is not essential.

The heater element structure is sized and shaped to fit into the body of the housing 10 of the fill port assembly and so the number of loops will correspond to the number of ports in the assembly and the size and spacing of the loops will correspond to the size and spacing of the ports. The ends 211, 212 of the structure are preferably arranged to extend from an end 10′a of the housing body when the loops are located around the openings for the ports.

To allow connection to a power supply (not shown here) a connector 250 can be fitted to the end 10′a of the housing and to the heater element ends 211, 212.

Preferably, the heater element is made of a CNT material, more preferably a CNT yarn which can be easily shaped to form the loops and is thin so as to be easily located inside the housing 10′ body without the need to increase the dimensions of the housing.

To further improve the heat transfer properties of the heater element around the port openings, the CNT material may be laminated with a resin 260 which provides electrical insulation combined with good heat transfer properties e.g. epoxy, silicone or ceramic resin.

Seals 270 may also be provided within the port openings to ensure the assembly is waterproof and to protect the heating assembly against leaks in the water flow path.

An inner copper sleeve 280 may be provided within each opening to protect the heater element against mechanical and environmental damage from the port/water/dust etc.

When current is applied to the heater element e.g. via connector 250, the heater element loop 220a generates heat. Where CNT material is used for the loop, heat can be generated very quickly since CNT materials have excellent electrical conductivity. Where present, the resin 260 that embeds the coil provides electrical insulation between the port and the power supply. Heat is transferred from the heater loop into the surrounding resin and copper sleeve, where present, to create a heating area around the port opening where freezing is most likely. The location and structure of the heater assembly around the port opening is such as to reduce heat transfer to areas which are not relevant i.e. areas which do not need to be heated.

Carbon nanotubes have only recently been developed, and the use of such material as a heater for a fill port assembly, as described herein, is a new and advantageous application for such material due to its excellent heat transfer properties and its thinness and light weight and its flexibility to form desired shapes.

CNT has become available as a continuous yarn, which has been found to be particularly useful for the heater element of this disclosure. Its thermal conductivity is in the order of ten times that of copper.

The thermal properties of the heater element of this disclosure can be seen in FIG. 6, where lines H and h show the directions in which heat is generated from the heater element loop 220a. This can be compared to the heat emission shown by lines 150 of the conventional heater assemblies (see FIG. 2). From this, it can be seen that the heat area of the new heater assembly is much more concentrated in the critical areas (see areas 140 in FIG. 2) where heat is needed, where ice can typically start to form, and there is, therefore, much less heat waste.

The solution of this disclosure, therefore, provides a much more efficient heater with relatively reduced energy consumption, as well as being small, simple and light. Assembly is simple and quick and does not require precise manufacture and assembly procedures as in the conventional designs. The heater element can be easily manufactured for/adapted to different sizes and shapes of port assembly.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the

1. A heater assembly comprising:
a heater assembly housing having a housing body with one or more port openings formed therethrough; and
a heater element located within the housing body and shaped to form a heater loop around each of the one or more port openings.

2. The heater assembly of claim 1, wherein the heater element has a wire or yarn structure having first and second ends and wound or bent to form the one or more loops between the first and second ends.

3. The heater assembly of claim 2, wherein the heater element is formed of a carbon nanotube (CNT) material.

4. The heater assembly of claim 3, wherein the heater element is formed of a CNT yarn.

5. The heater assembly of claim 1, further comprising:
a connector to provide connection between a power supply and the heater element.

6. The heater assembly of claim 5, wherein the connector is attached to first and second ends of the heater element.

7. The heater assembly of claim 1, further comprising:
a resin formed around each of the one or more heater loops.

8. The heater assembly of claim 7, wherein the resin is one of epoxy, silicone or ceramic.

9. The heater assembly of claim 1, further comprising:
a copper sleeve within the one or more loops.

10. The heater assembly of claim 1, wherein the housing body is formed of ceramic.

11. The heater assembly of claim 5, wherein the housing is rectangular, and wherein the connector is in the form of a plug attached to an end of the housing.

12. A fill port assembly comprising:
a heater assembly as claimed in claim 1; and
one or more ports extending through a respective one of the one or more port openings.

13. A fill port assembly as claimed in claim 12, wherein the heater assembly housing comprises two ports and the fill port assembly comprises a fill port and an overflow port.

14. A method of providing a heater assembly as claimed in claim 1 for a fill port assembly having one or more fill ports, the method comprising:
forming the one or more heater loops in the heater element;
locating the heater element in the heater assembly housing such that the one or more loops are located around the one or more openings; and
positioning the heater assembly housing such that the one or more fill ports extends through respective ones of the one or more openings.

15. The method of claim 14, further comprising applying current to the heater element to generate heat.
